(19) United States
(12) Patent Application Publication
(10) Pub. No.: US 2015/0185982 A1
(43) Pub. Date: Jul. 2, 2015

(54) CONTENT FLAGGING TECHNIQUES FOR DIGITAL CONTENT

(71) Applicant: barnesandnoble.com llc, New York, NY (US)

(72) Inventors: Kourtny M. Hicks, Sunnyvale, CA (US); Amir Mesguich Havilio, Palo Alto, CA (US); Dale J. Brewer, San Marcos, CA (US)

(73) Assignee: barnesandnoble.com llc, New York, NY (US)

(21) Appl. No.: 14/144,889

(22) Filed: Dec. 31, 2013

(51) Int. Cl. G06F 3/0483; G06F 3/041; G06F 3/0484

(52) U.S. Cl. CPC G06F 3/0483; G06F 3/04842; G06F 3/04847; G06F 3/041

(57) ABSTRACT

Techniques are disclosed for providing a side flag mode in electronic devices. In an embodiment, a touch screen gesture performed over a side flag marker may activate the side flag. An activated side flag may be color coded and/or assigned an icon in order to organize the side flags or denote a level of importance or interest. Such side flags are linked to the reflowable digital content rather than a page number, such that when formatting settings are adjusted, the side flags follow an assigned section of text as the text is reflowed and reorganized over a device viewport. The side flag mode may allow the user to organize a table of contents to display only the sections of content associated with activated side flags, and these sections of content may also be organized based on the color or type of side flags the user has created.

### FIELD OF THE DISCLOSURE

This disclosure relates to electronic display devices, and more particularly, to user interface (UI) techniques for interacting with computing devices.

### BACKGROUND

Electronic display devices such as tablets, eReaders, mobile phones, smart phones, personal digital assistants (PDAs), and other such touch screen electronic display devices are commonly used for displaying consumable content. The content may be, for example, one or more eBooks, images, video or music files, document files, an online article or blog, a map, just to name a few types. Such display devices are also useful for displaying a user interface that allows a user to interact with an application running on the device. The user interface may include, for example, one or more touch screen controls and/or one or more displayed labels that correspond to nearby hardware buttons. The touch screen display may be backlit or not, and may be implemented for instance with an LED screen or an electrophoretic display. Such devices may also include other touch sensitive surfaces, such as a track pad (e.g., capacitive or resistive touch sensor) or touch sensitive housing (e.g., acoustic sensor).

### BRIEF DESCRIPTION OF THE DRAWINGS

FIGS. 1a-b illustrate an example electronic touch screen device having a side flag mode configured in accordance with an embodiment of the present invention.

FIGS. 1c-d illustrate example configuration screen shots of the user interface of the electronic touch screen device shown in FIGS. 1a-b, configured in accordance with an embodiment of the present invention.

FIG. 2a illustrates a block diagram of an electronic touch screen device configured in accordance with an embodiment of the present invention.

FIG. 2b illustrates a block diagram of a communication system including the electronic touch screen device of FIG. 2a, configured in accordance with an embodiment of the present invention.

FIGS. 3a-e illustrate an example electronic touch screen device having color coded side flags, in accordance with an embodiment of the present invention.

FIGS. 4a-d illustrate an example electronic touch screen device having multiple side flags in one viewport, in accordance with another embodiment of the present invention.

FIGS. 5a-d illustrate example screen shots showing a single side flag spanning multiple viewports, in accordance with an embodiment of the present invention.

FIGS. 6a-b illustrate different side flag positions based on the orientation of an electronic touch screen device, in accordance with an embodiment of the present invention.

FIGS. 7a-d illustrate examples of side flags linked to reflowable digital content, in accordance with an embodiment of the present invention.

FIGS. 8a-b illustrate screen shots of two side flag tables of contents, in accordance with two embodiments of the present invention.

FIG. 9 illustrates a method for providing a side flag mode in an electronic touch screen device, in accordance with an embodiment of the present invention.

### DETAILED DESCRIPTION

Techniques are disclosed for providing a side flag mode in electronic computing devices, such as a touch screen device. The techniques disclosed herein may also be implemented in a browser or other data consumption interface configured to receive user input from a touch sensitive screen, a track-pad, a mouse, or other suitable user input mechanism, in some embodiments. The user can activate a side flag, for example, by performing an activation gesture over a side flag marker or place holder. In some embodiments, the activation gesture can be a horizontal swipe performed over the flags using a finger, stylus, a hover-over mouse gesture, or any other suitable user input mechanism. When activated, the side flag may be shaded a specific color, while a deactivated side flag may be transparent, invisible, or only an outline of a side flag, in some embodiments. In one example, the side flags could also display numbers associated with the original page numbering of the digital content. The side flags may also be color coded, in some embodiments, or be assigned an icon in order to organize the flagged material based on level of importance or interest or other organizing factor. Such side flags can be linked to the reflowable digital content rather than a temporary page or viewport number, such that when formatting settings such as font, font size, margin layout, etc. are adjusted, the side flags will follow an assigned section of text after a reflow event wherein the text is reflowed over a device viewport. As such, a single side flag may sometimes span multiple viewports or screenshots, while at other times a single viewport may display multiple side flags. The side flag mode may allow the user, in some embodiments, to organize a table of contents to display only the sections of content associated with activated side flags. The table of contents may also be organized based on the color or type of side flags the user has created, in some embodiments. These table of contents features may allow a user to easily outline a piece of digital content, such as a textbook, based on customized side flags.

General Overview

As previously explained, electronic display devices such as tablets, eReaders, and smart phones are commonly used for displaying user interfaces and consumable content. The user of such devices can typically consume the displayed content with relative ease. In some instances, the user may wish to bookmark certain portions of the digital content. After adding a bookmark to a page of content, the user may further wish to adjust content viewing settings, such as font, font size, or margin layout, in some embodiments. When text formats are changed (e.g., font size, font, line spacing, margin spacing, switching from landscape to portrait mode or back), the text normally reflows in a non-fixed format. In some cases, the flowable digital content could be a file formatted as, for example, an ePub, iBook, .lit, or any other suitable file format for presenting flowable digital content on a touch screen device. As a result of this reflow process, the bookmarks attached to the original page numbers inevitably get separated from their intended positions in the text because there is no way to tell where the start or end of the bookmark should be. While general functions suitable for adding or removing digital bookmarks may be available in some electronic devices, a side flag mode as described herein may provide a more intuitive or otherwise positive user experience.

Thus, and in accordance with an embodiment of the present invention, side flag techniques are disclosed for use in electronic devices. The electronic device may be, for example, a touch screen device or an electronic device having a mouse and/or trackpad configured to receive user input. Such side flags may be linked to the reflowable digital content itself, rather than unfixed page numbers displayed on the electronic device, such that after a reflow event wherein the digital content is reflowed and the pages of the content are renumbered, the side flags remain in their intended locations. In some embodiments, the side flags are assigned a location based on the original page numbering of an eBook or other item of digital content, and the flags may originally be located in the upper right corner of the device screen. Side flags may be activated in response to an activation gesture, which may be a single finger tap or mouse click performed over a side flag marker or place holder, in some embodiments. The side flags may begin as markers or place holders that are blank or partially shaded in some embodiments, and they may be darkened or otherwise activated when the user taps or selects the flag marker. In some cases, tapping an activated side flag will deactivate the side flag. In other embodiments, the side flag markers may be invisible and only displayed when activated, or in response to user command.

The side flags may be assigned various colors or icons, in some embodiments that may denote a level of importance, interest, or other distinction. For example, the user may assign a question mark, exclamation point, or asterisk to a particular side flag to respectively denote that the user has a question about the flagged material, that the flagged material is important, or that the flagged material may be on a test. For ease of reference and citations, flags could also display numbers associated with the original page numbering of the physical (analog) content, such that the digital side flags map exactly to physical page numbers. In such an example, a student may have a reading assignment designating chapters and/or page ranges and the side flags allow the student to read the appropriate assignment in a digital format. If various colors are available for the side flags, a newly activated side flag may adopt the color of the last-created side flag. If no side flag has been created previously, a default flag color may be used. Many other color schemes, labels, icons, or other identifiers may be applied to the side flags, as will be appreciated, and the present disclosure is not intended to be limited to any particular color scheme or type of identifier.

Editing the color or icon assigned to a side flag may be done, for example, using a swipe gesture or other distinguishable touch screen gesture, or a mouse hover-over action performed over an existing side flag or a side flag marker. In one embodiment, the user may swipe or hover with the mouse away from the edge of the screen at the side flag place holder in order to view the side flag color options. Alternatively, the user could also swipe downward or upward from the side flag place holder to view color options and/or icon options. In one embodiment, a swipe gesture displays the color and/or icon options cascading away from the edge of the screen, and a tap gesture or mouse click performed over the desired option assigns it to the side flag. In another embodiment, a swipe-and-hold gesture displays the color and/or icon options and the user may select a desired option by releasing contact with the touch screen surface over the desired option. In some embodiments, tapping away from the color and/or icon options or releasing contact away from the options can abandon the side flag activation. Performing a swipe gesture over a currently activated side flag may display the side flag color options, in some embodiments, allowing the user to change the color or deactivate the side flag by selecting the current color. Once a color and/or icon option has been selected or the side flag activation has been abandoned, the options list that previously cascaded away from the side flag marker may retract, in some embodiments. The options may retract with a bounce animation that gradually settles and rests, leaving the side flag in the desired color or other state. The animation may show the options recoiling like blinds, a projector screen, or window shade that was pulled down and released, and the animation may be accompanied by sound effects and/or graphics in some embodiments.

In some examples, the digital content is a fixed format file and the side flag mode may be used as a bookmark function with one selectable and configurable flag per page. In one embodiment, fixed format digital content may be displayed in the landscape orientation having a spread of two pages with the flags in the upper right corner for the right page and the upper left corner for the left page. In such examples, the side flags may be displayed in the same location consistently on every page (e.g., the upper right corner for a single page view and both upper corners for a page spread view), and the section of the touch screen assigned to side flags may be reserved for the side flags and for receiving flagging gestures. In other embodiments, reflowable digital content may be displayed as a two-page spread in landscape orientation having the flags for the right hand page on the right margin and flags for the left hand page on the left margin.

In some embodiments, a single side flag is associated with a single page of text with a set font size and margin format. In such an example, the side flags may track the original page numbering of a piece of physical content, such as a book or magazine, and the flags may be located at the lines where an original page break existed (i.e., at the beginning of every text range considered to be a page). However, when the user decreases the font size of the digital content, the text reflows within the viewport and a single viewport or screenshot may display multiple pages worth of text, and therefore multiple side flags, in some embodiments. In such an example, if one of the side flags is activated (e.g., by tapping or selecting a color option for the side flag), the flag is associated with the content between the original page breaks rather than all the content currently displayed on the viewport. In some such embodiments, any text not within the range of the newly activated side flag can temporarily appear lighter or otherwise partially obscured. The text may remain lighter for a short time (e.g., about two or three seconds), in some embodiments, before regaining full color, in order to demonstrate to the user what textual content is associated with the newly activated side flag. In other embodiments, after zooming in or increasing the font size of digital content, a single side flag may span multiple viewports or screenshots. In such embodiments, the flag may be repeated at as many viewports as needed. If the user turns on or off such a side flag, changes its color, assigns an icon to it, or other action, the changes may be reflected across all the viewports it encompasses. Notes or annotations may be added to the digital content and linked to the side flags, in some embodiments, rather than the variable page numbers. In such embodiments, the notes will follow the side flags and remain associated with the desired content after the digital content is reflowed.

In other embodiments, side flags may be pulled in from either the right or left edges of the display in order to bookmark a line of digital content. Such bookmarks do not identify the original page numbering of digital content, but are rather reflowable side flags that can follow an assigned section of text as the text is reflowed over a device viewport. In some embodiments, the side flag may be pulled from a side flag icon or from the edge of the screen and dragged to the line where the bookmark is desired. As described above, such side flags may be assigned colors and/or icons. Because these side flags do not denote the location of a page break in the original content, when deactivated such side flags may completely disappear without leaving a side flag place marker.

As used herein, a swipe gesture may include a sweeping or dragging gesture across at least a portion of the touch sensitive surface; whether directly contacting that surface or hovering over that surface (e.g., within a few centimeters or otherwise close enough to be detected by the touch sensitive surface). In some embodiments, the swipe gesture may be performed at a constant speed in one single direction, while in other embodiments the swipe gesture may follow a curved path or otherwise non-straight path. In one embodiment, when flags are on the right margin, a swipe out from right to left reveals a flag color picker. Once expanded, a swipe in the opposite direction, from left to right, closes the color picker without performing any action (i.e., without changing flag color or unflagging/flagging content). The gestures can be performed, for example, with the tip of a finger or a stylus, or any other suitable implement capable of providing a detectable swipe gesture. Given the global nature and/or uniqueness of the engagement mechanism, in accordance with some example embodiments, the side flags described herein can be similarly enabled within multiple diverse applications (e.g., document viewer, browser, eReader, etc.) and without conflicting with other global gestures that might also be used by the device's operating system. Various types of digital content can benefit from the side flags described herein. For example, the digital content may include a digital catalogue, magazine, comics, eBook, text document, and/or other digital content that may be accessed through the UI of a digital computing device.

The techniques have a number of advantages, as will be appreciated in light of this disclosure. For instance, in some cases, the techniques can be employed to provide an intuitive way for a student to annotate and study course materials. In one such embodiment, a student can activate and color code side flags at various sections of a textbook. A student can also assign icons, such as an asterisk, exclamation point, etc. to the various side flags in order to rank them by priority or importance. As used herein, the term “icon” refers to any identifying symbol or graphic that may be assigned to a side flag for distinguishing the side flag from other side flags. In some cases, the user can view a table of contents or index of the annotated textbook in order to see which portions of a book have been flagged for future review and create a course outline. In one example embodiment, a table of contents may be organized to show the chapters, sections, page numbers, etc. where side flags have been added by the user, and these page references may also be organized by the type or color of side flag the user has created.

Architecture

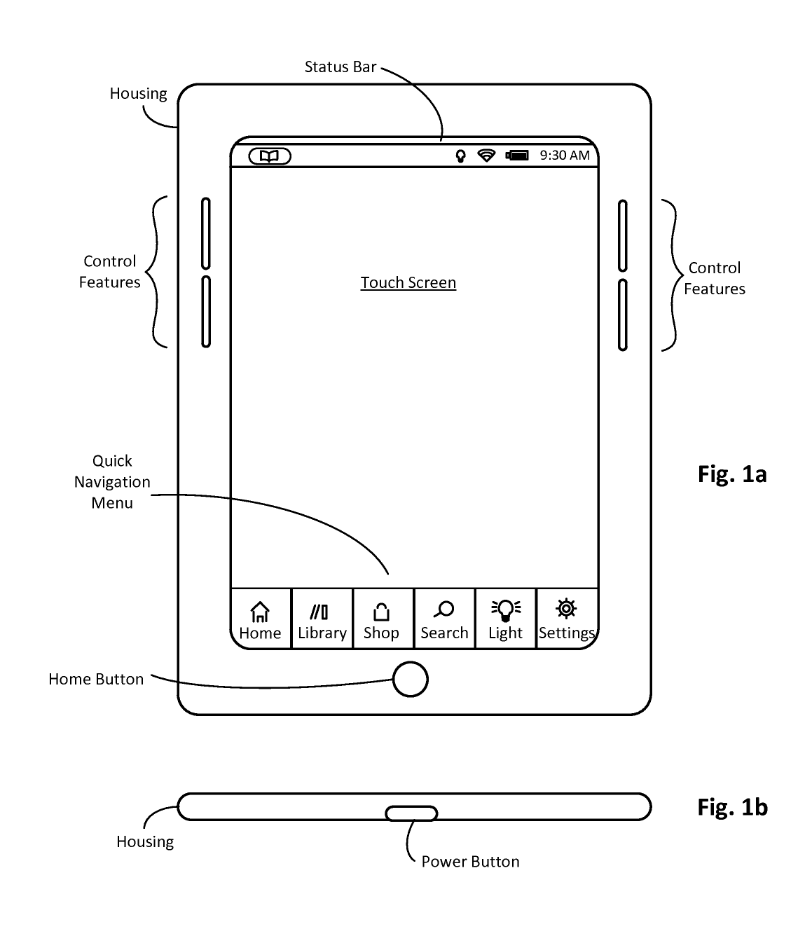

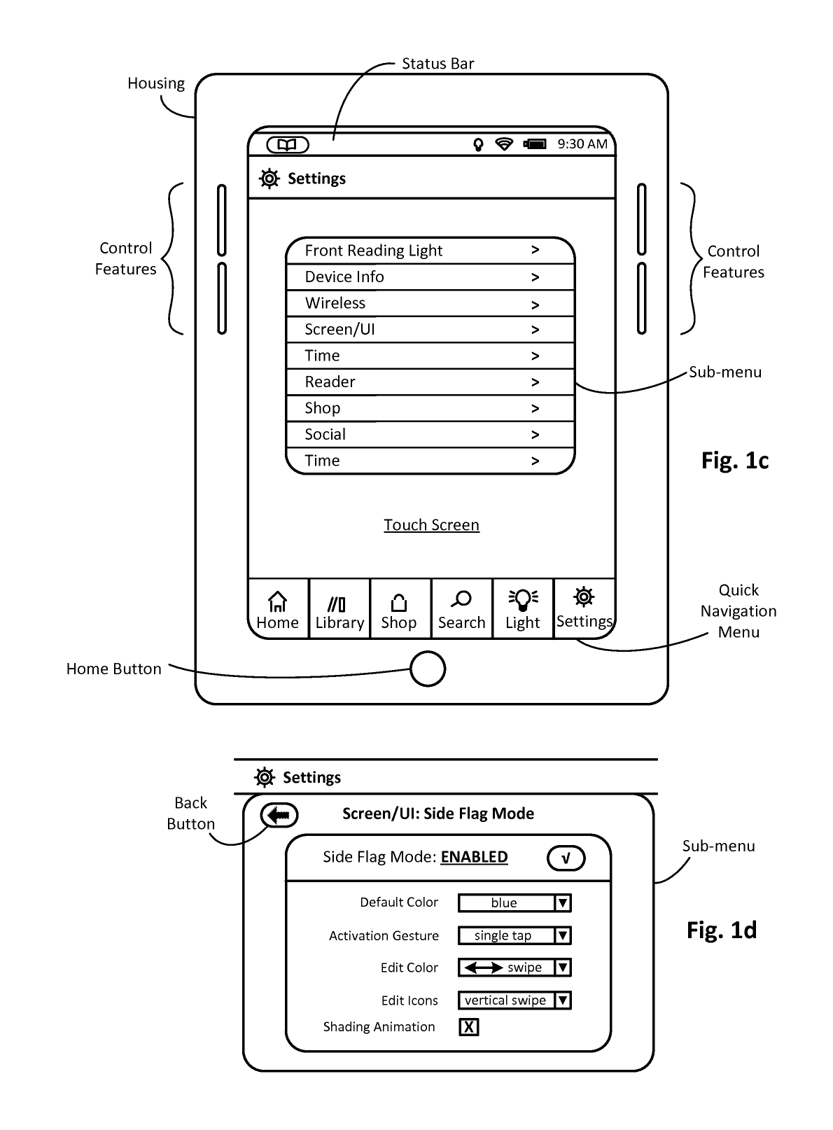

FIGS. 1a-b illustrate an example electronic touch sensitive device having a digital flash card function configured in accordance with an embodiment of the present invention. As can be seen, in this example embodiment, the touch sensitive surface is a touch screen display. The device could be, for example, a tablet such as the NOOK® tablet or eReader by Barnes & Noble. In a more general sense, the device may be any electronic device having a touch sensitive user interface for detecting direct touch or otherwise sufficiently proximate contact, and capability for displaying content to a user, such as a mobile phone or mobile computing device such as a laptop, a desktop computing system, a television, a smart display screen, or any other device having a touch sensitive display or a non-sensitive display screen that can be used in conjunction with a touch sensitive surface. As will be appreciated in light of this disclosure, the claimed invention is not intended to be limited to any specific kind or type of electronic device or form factor.

As can be seen with this example configuration, the device comprises a housing that includes a number of hardware features such as a power button, control features, and a press-button (sometimes called a home button herein). A user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI features, or different UI features altogether, depending on the target application of the device. Any such general UI controls and features can be implemented using any suitable conventional or custom technology, as will be appreciated.

The hardware control features provided on the device housing in this example embodiment are configured as elongated press-bars and can be used, for example, to page forward (using the top press-bar) or to page backward (using the bottom press-bar), such as might be useful in an eReader application. The power button can be used to turn the device on and off, and may be used in conjunction with a touch-based UI control feature that allows the user to confirm a given power transition action request (e.g., such as a slide bar or tap point graphic to turn power off). Numerous variations will be apparent, and the claimed invention is not intended to be limited to any particular set of hardware buttons or UI features, or device form factor.

In this example configuration, the home button is a physical press-button that can be used as follows: when the device is awake and in use, pressing the button will display the quick navigation menu, which is a toolbar that provides quick access to various features of the device. The home button may also be configured to cease an active function that is currently executing on the device, or close a configuration sub-menu that is currently open. The button may further control other functionality if, for example, the user presses and holds the home button. For instance, an example such push-and-hold function could engage a power conservation routine where the device is put to sleep or an otherwise lower power consumption mode. So, a user could grab the device by the button, press and keep holding as the device is stowed into a bag or purse. Thus, one physical gesture may safely put the device to sleep. In such an example embodiment, the home button may be associated with and control different and unrelated actions: 1) show the quick navigation menu; 2) exit a configuration sub-menu; and 3) put the device to sleep. As can be further seen, the status bar may also include a book icon (upper left corner). In some cases, selecting the book icon may provide bibliographic information on the content or provide the main menu or table of contents for the book, movie, playlist, or other content.

In one particular embodiment, a side flag mode configuration sub-menu, such as the one shown in FIG. 1d, may be accessed by selecting the Settings option in the quick navigation menu, which causes the device to display the general sub-menu shown in FIG. 1c. From this general sub-menu, the user can select any one of a number of options, including one designated Screen/UI in this specific example case. Selecting this sub-menu option may cause the configuration sub-menu of FIG. 1d to be displayed, in accordance with an embodiment. In other example embodiments, selecting the Screen/UI option may present the user with a number of additional sub-options, one of which may include a so-called “side flag mode” option, which may then be selected by the user so as to cause the side flag mode configuration sub-menu of FIG. 1d to be displayed. Any number of such menu schemes and nested hierarchies can be used, as will be appreciated in light of this disclosure. In other example embodiments, the side flag mode is hard-coded such that no configuration sub-menus are needed or otherwise provided (e.g., activating and color-coding side flags as described herein, with no user configuration needed). The degree of hard-coding versus user-configurability can vary from one embodiment to the next, and the claimed invention is not intended to be limited to any particular configuration scheme of any kind, as will be appreciated.

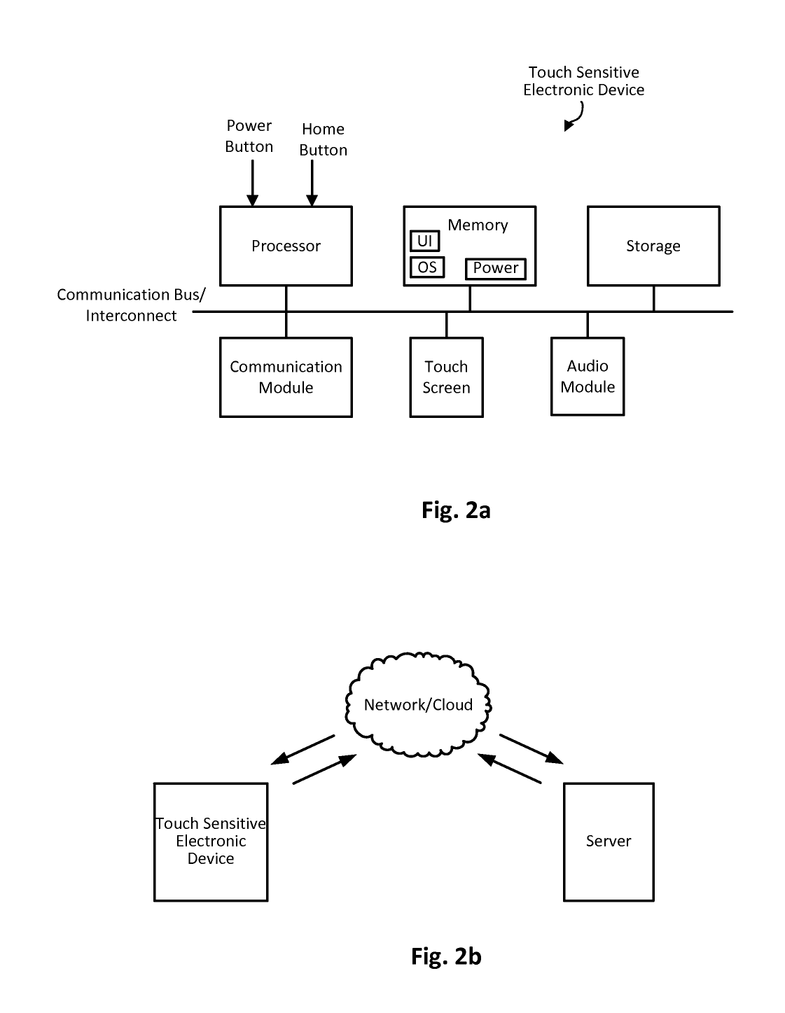

As will be appreciated, the various UI control features and sub-menus displayed to the user are implemented as touch screen controls in this example embodiment. Such UI screen controls can be programmed or otherwise configured using any number of conventional or custom technologies. In general, the touch screen display translates a touch (direct or hovering, by a user's hand, a stylus, or any other suitable implement) in a given location into an electrical signal which is then received and processed by the device's underlying operating system (OS) and circuitry (processor, display controller, etc.). In some instances, note that the user need not actually physically touch the touch sensitive device to perform an action. For example, the touch screen display may be configured to detect input based on a finger or stylus hovering over the touch sensitive surface (e.g., within 3 centimeters of the touch screen or otherwise sufficiently proximate to be detected by the touch sensing circuitry). Additional example details of the underlying OS and circuitry in accordance with some embodiments will be discussed in turn with reference to FIG. 2a.

The touch sensitive surface (or touch sensitive display, in this example case) can be any surface that is configured with touch detecting technologies, whether capacitive, resistive, acoustic, active-stylus, and/or other input detecting technology, including direct contact and/or proximate contact. In some embodiments, the screen display can be layered above input sensors, such as a capacitive sensor grid for passive touch-based input, such as with a finger or passive stylus contact in the case of a so-called in-plane switching (IPS) panel, or an electro-magnetic resonance (EMR) sensor grid for sensing a resonant circuit of a stylus. In some embodiments, the touch sensitive display can be configured with a purely capacitive sensor, while in other embodiments the touch screen display may be configured to provide a hybrid mode that allows for both capacitive input and EMR input, for example. In still other embodiments, the touch sensitive surface is configured with only an active stylus sensor. Numerous touch screen display configurations can be implemented using any number of known or proprietary screen based input detecting technologies. In any such embodiments, a touch sensitive controller may be configured to selectively scan the touch sensitive surface and/or selectively report user inputs detected directly on or otherwise sufficiently proximate to (e.g., within a few centimeters, or otherwise sufficiently close so as to allow detection) the detection surface (or touch sensitive display, in this example case).

As previously explained, and with further reference to FIGS. 1c and 1d, once the Settings sub-menu is displayed (FIG. 1c), the user can then select the Screen/UI option. In response to such a selection, the side flag mode configuration sub-menu shown in FIG. 1d can be provided to the user, in accordance with one such example embodiment. The user can configure a number of features with respect to the side flag mode, in this example case. For instance, the configuration sub-menu includes a UI check box that when checked or otherwise selected by the user, effectively enables the side flag mode (shown in the enabled state); unchecking the box disables the function. Other embodiments may have the side flag mode always enabled or enabled by a physical switch or button located on the device, for example.

In some embodiments, the side flag mode may be associated with a default color. In this particular embodiment, the default side flag color is set to blue, such that new side flags are shaded blue unless another color option is selected. Once one side flag has been created with a different color, however, the next side flag may adopt the color of the last-activated side flag, in some embodiments. The side flag mode may further be associated with a number of gestures, including an activation gesture, an edit color gesture, and an edit icon gesture. In some embodiments, the user may configure the various gestures described above, and in this particular embodiment, the user has selected a tap gesture as the side flag activation gesture, a horizontal swipe gesture (oriented away from the edge of the device screen) as the color editing gesture, and a vertical swipe gesture as the icon editing gesture, each performed over a side flag marker or place holder. In a mouse/keyboard based electronic device, the side flag activation gesture, color editing gesture, and icon editing gesture could be, for example, a hover-over mouse gesture, a mouse click, a click-and-drag mouse gesture, or other distinguishable user input command. Other embodiments may use different gestures, such as a two-contact swipe gesture, a distinguishable tap gesture, or any other recognizable gesture that can be used to distinctly indicate that a specific function is desired. As can be seen in this example, the default color and desired gestures have been selected from drop-down menus, but any suitable UI selection mechanism can be used. In still other embodiments, note that a touch screen gesture is not necessarily required. For instance, in a desktop computing application having a non-touch display and a mouse, the so-called gestures may be performed by the user dragging a cursor or selecting with a cursor (e.g., via a click-and-hold mouse-based drag, a hover-over command, or a mouse click) using a keyboard, mouse, or other suitable input mechanism. In a more general sense, any suitable user input techniques can be used to interact with the side flag mode provided herein. For ease of description, examples provided herein focus on touch screen technologies.

With further reference to the example embodiment of FIG. 1d, the user has the option to enable a shading animation that can shade out portions of digital content if multiple side flags are shown on a single viewport and an action is performed on only one of those side flags. As discussed above, in some embodiments multiple side flags may be displayed on a single viewport and the user may wish to activate or change the color of only one of the side flags. In such an example, the text not associated with the newly activated side flag may be shaded temporarily (e.g., for a few seconds) and slowly return to the original text color. As can be seen in this example, a touch screen UI check box has been used to enable the animation option. As mentioned above, many other gestures and/or features may be configured or edited with respect to the side flag mode, and this example figure is not intended to limit the disclosure to any particular type of gestures and/or features.

As can be further seen, a back button arrow UI control feature may be provisioned on the screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. The configuration sub-menu shown in FIG. 1d is presented merely as an example of how a side flag mode may be configured by the user, and numerous other configurable or hard-codable aspects will be apparent in light of this disclosure. Note that in some embodiments the side flag mode may be visually and/or aurally demonstrated or otherwise confirmed to the user via animations and/or sound effects. Such animations and sound effects may be used to provide clarity to the function being performed or otherwise enhance the user experience. In some embodiments, such animations and sound effects may be user-configurable, while in other embodiments they are hard-coded.

FIG. 2a illustrates a block diagram of an electronic touch screen device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc.). The touch screen and underlying circuitry is capable of translating a user's contact (direct or proximate) with the touch screen into an electronic signal that can be manipulated or otherwise used to trigger a specific user interface action, such as those provided herein. The principles provided herein equally apply to any such touch sensitive devices. For ease of description, examples are provided with touch screen technology.

In this example embodiment, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device including a UI having a side flag mode as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., Texas Instruments OMAP4, dual-core ARM Cortex-A9, 1.5 GHz), and may include one or more co-processors or controllers to assist in device control. In this example case, the processor receives input from the user, including input from or otherwise derived from the power button and the home button. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory). The display can be implemented, for example, with a 7 to 9 inch 1920×1280 IPS LCD touchscreen touch screen, or any other suitable display and touchscreen interface technology. The communications module can be, for instance, any suitable 802.11 b/g/n WLAN chip or chip set, which allows for connection to a local network, and so that content can be exchanged between the device and a remote system (e.g., content provider or repository depending on the application of the device). In some specific example embodiments, the device housing that contains all the various componentry measures about 7″ to 9″ high by about 5″ to 6″ wide by about 0.5″ thick, and weighs about 7 to 8 ounces. Any number of suitable form factors can be used, depending on the target application (e.g., laptop, desktop, mobile phone, etc.). The device may be smaller, for example, for smartphone and tablet applications and larger for smart computer monitor and laptop and desktop computer applications.

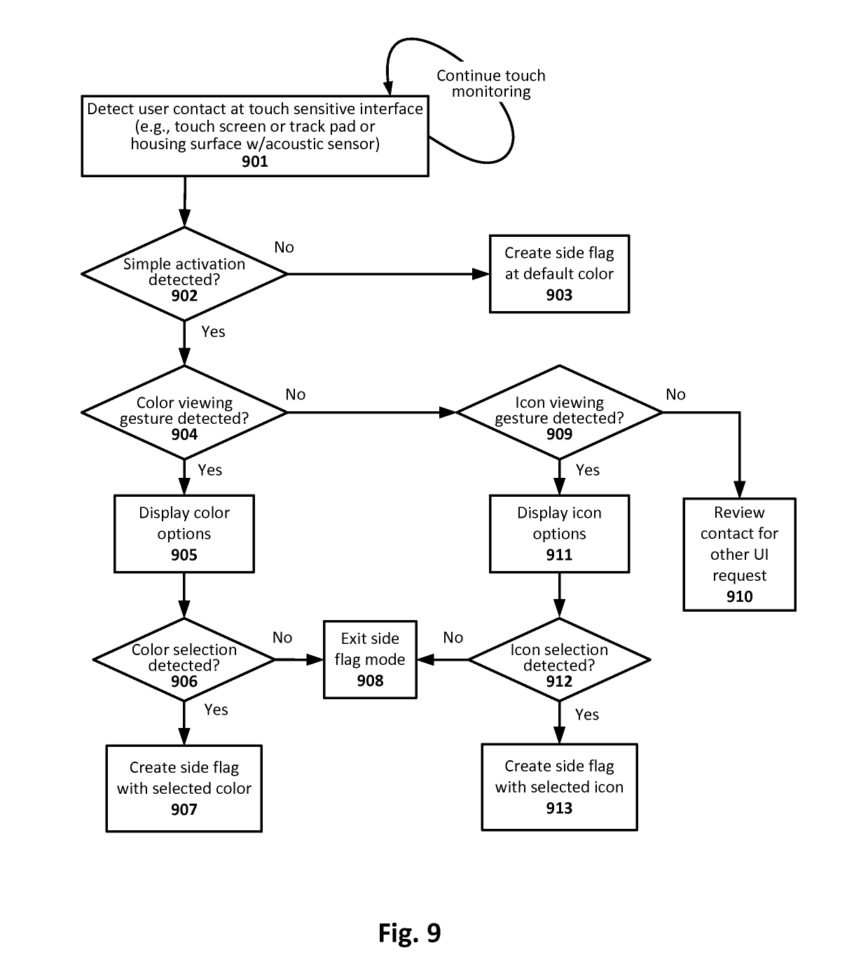

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The UI module can be, for example, based on touchscreen technology and the various example screen shots and use-case scenarios shown in FIGS. 1a, 1c-d, 3a-e, 4a-d, 5a-d, 6a-b, 7a-d, and 8, and in conjunction with the side flag methodologies demonstrated in FIG. 9, which will be discussed in turn. The audio module can be configured to speak or otherwise aurally present, for example, a digital content sample, a selected eBook, or other textual content, and/or to provide verbal and/or other sound-based cues and prompts to guide the side flag mode, as will be appreciated in light of this disclosure. Numerous commercially available text-to-speech modules can be used, such as Verbose text-to-speech software by NCH Software. In some example cases, if additional space is desired, for example, to store digital books or other content and media, storage can be expanded via a microSD card or other suitable memory expansion technology (e.g., 32 GBytes, or higher). Further note that although a touch screen display is provided, other embodiments may include a non-touch screen and a touch sensitive surface such as a track pad, or a touch sensitive housing configured with one or more acoustic sensors, etc.

Client-Server System

FIG. 2b illustrates a block diagram of a communication system configured in accordance with an embodiment of the present invention. As can be seen, the system generally includes an electronic touch sensitive device (such as the one in FIG. 2a) that is capable of communicating with a server via a network/cloud. In this example embodiment, the electronic touch sensitive device may be, for example, an eBook reader, a mobile cell phone, a laptop, a tablet, desktop, or any other touch sensitive computing device. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by performing a desired function or providing the user with requested or otherwise recommended content. Is some such embodiments, the server is configured to remotely provision a side flag mode as provided herein to the touch screen device (e.g., via JavaScript or other browser based technology). In other embodiments, portions of the side flag methodology can be executed on the server and other portions of the methodology can be executed on the device. Numerous server-side/client-side execution schemes can be implemented to facilitate a side flag mode in accordance with an embodiment, as will be apparent in light of this disclosure.

Side Flag Mode Examples

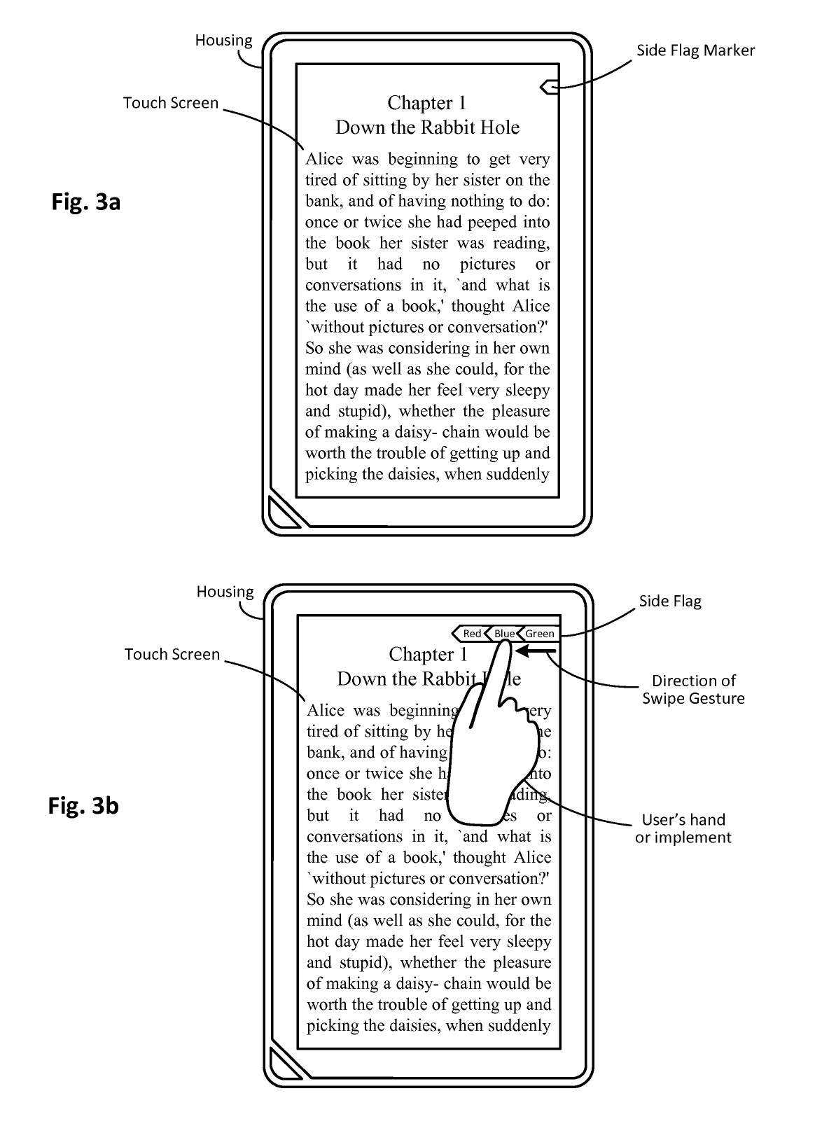

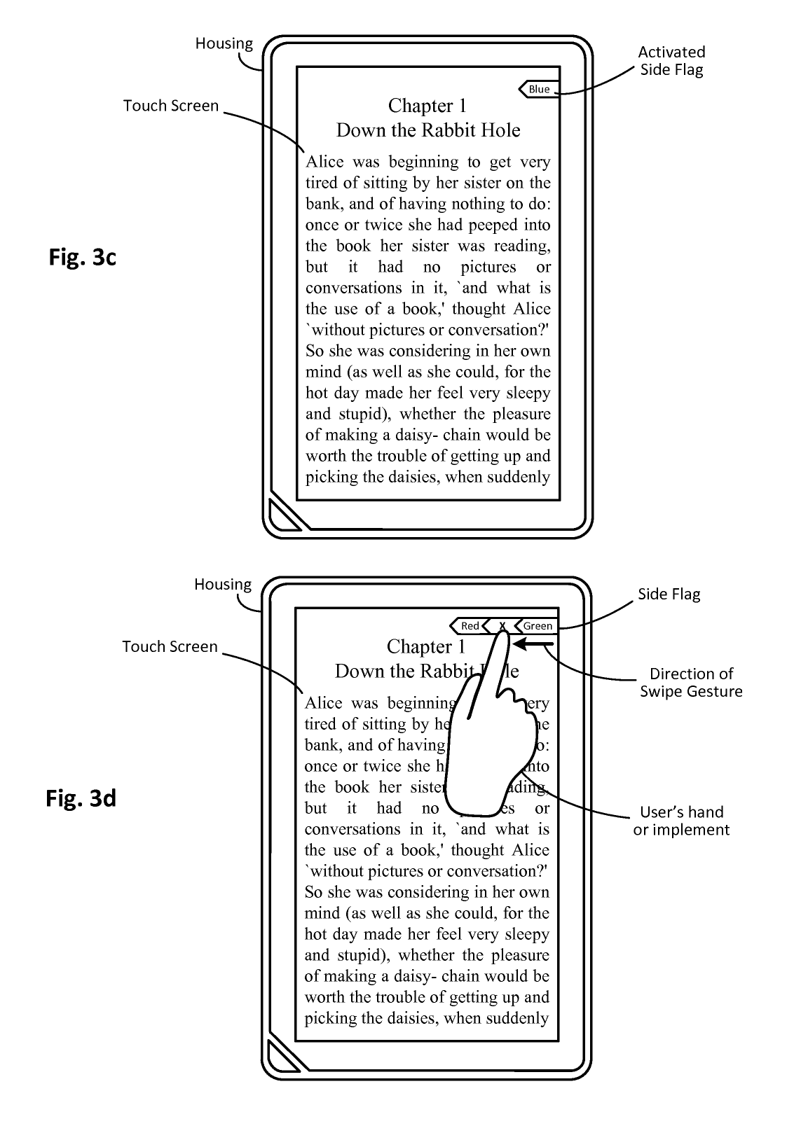

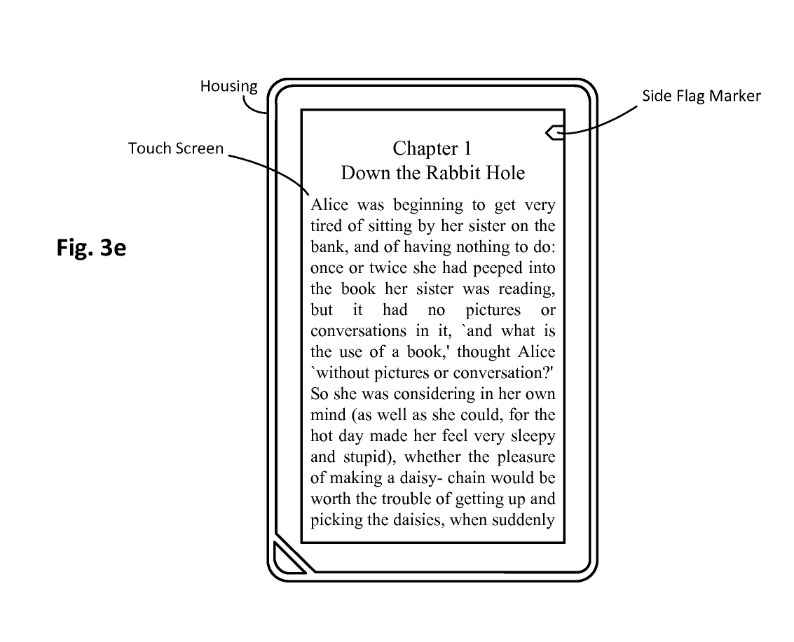

FIGS. 3a-e illustrate an example electronic touch screen device having color coded side flags, in accordance with an embodiment of the present invention. As can be seen in FIG. 3a, the device housing surrounds the touch screen of the device, and the device is displaying a page of text to the user. The user can interact with the touch screen with fingers or any other suitable implement, and in the upper right corner of the screen a side flag marker or place holder is displayed, in this particular example. As can be seen in FIG. 3b, the color coding gesture is configured (e.g., using the configuration sub-menu of FIG. 1d) to be a horizontal swipe gesture and the user has performed the swipe gesture in order to view the side flag color coding options. As discussed above, in some embodiments the user may perform a quick swipe gesture to display the color options and then tap on the desired color option, while in other embodiments the user may perform a swipe-and-hold gesture to view the color options and release contact with the touch screen over the desired color option in order to select that color. In this example embodiment, the user may select between red, blue, and green color options and has selected a blue side flag. An example of an activated blue side flag is shown FIG. 3c. The color options in this example embodiment are described for illustrative purposes only and numerous other color options will be apparent in light of this disclosure.

As can be seen in the example shown in FIG. 3d, once a side flag has been activated, the user may again perform a swipe gesture over the side flag marker in order to change the color of the side flag or deactivate the side flag. In this particular example, because the side flag is currently blue, the blue color option has an “X” over it indicating that selecting this option will deactivate the side flag. In other embodiments, a trash icon may be displayed over the currently selected color option. The user selects this option and the side flag is deactivated, as shown in the example of FIG. 3e. As discussed above, a deactivated side flag may be slightly shaded, be transparent apart from an outline, or be otherwise partially obscured, in various embodiments. In some instances, the side flag marker or place holder may be invisible and only displayed if a user contact is detected in the area assigned to side flag gestures.

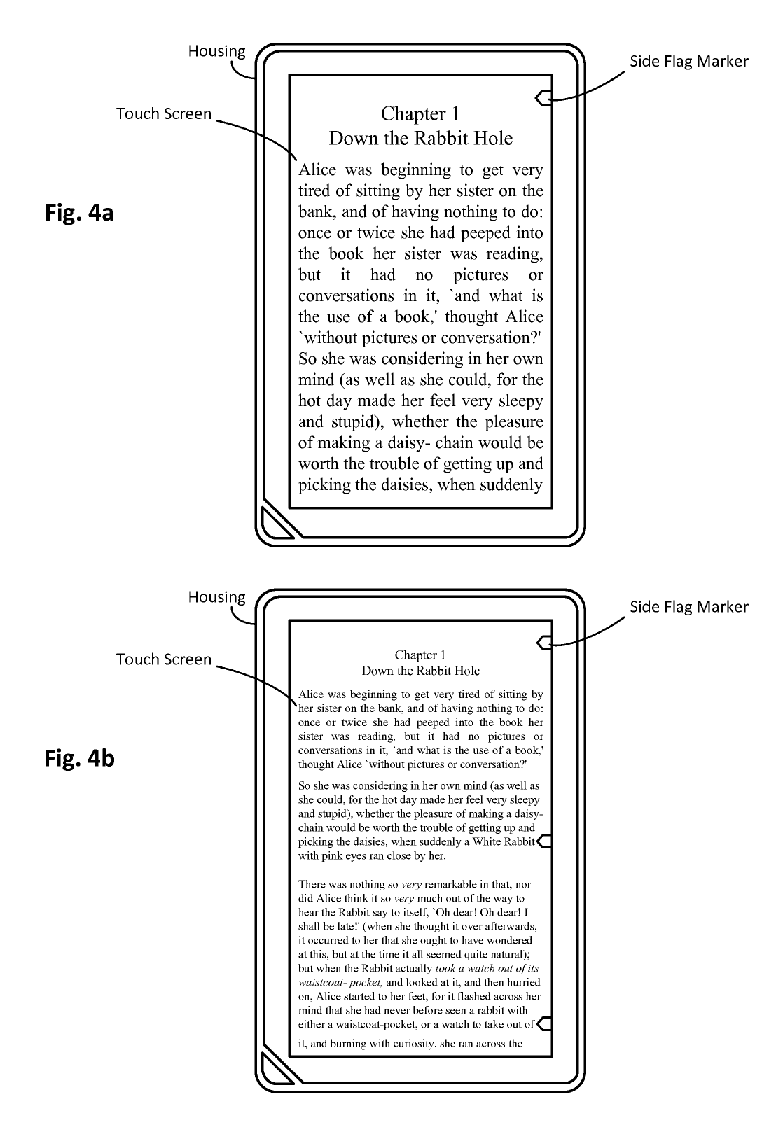

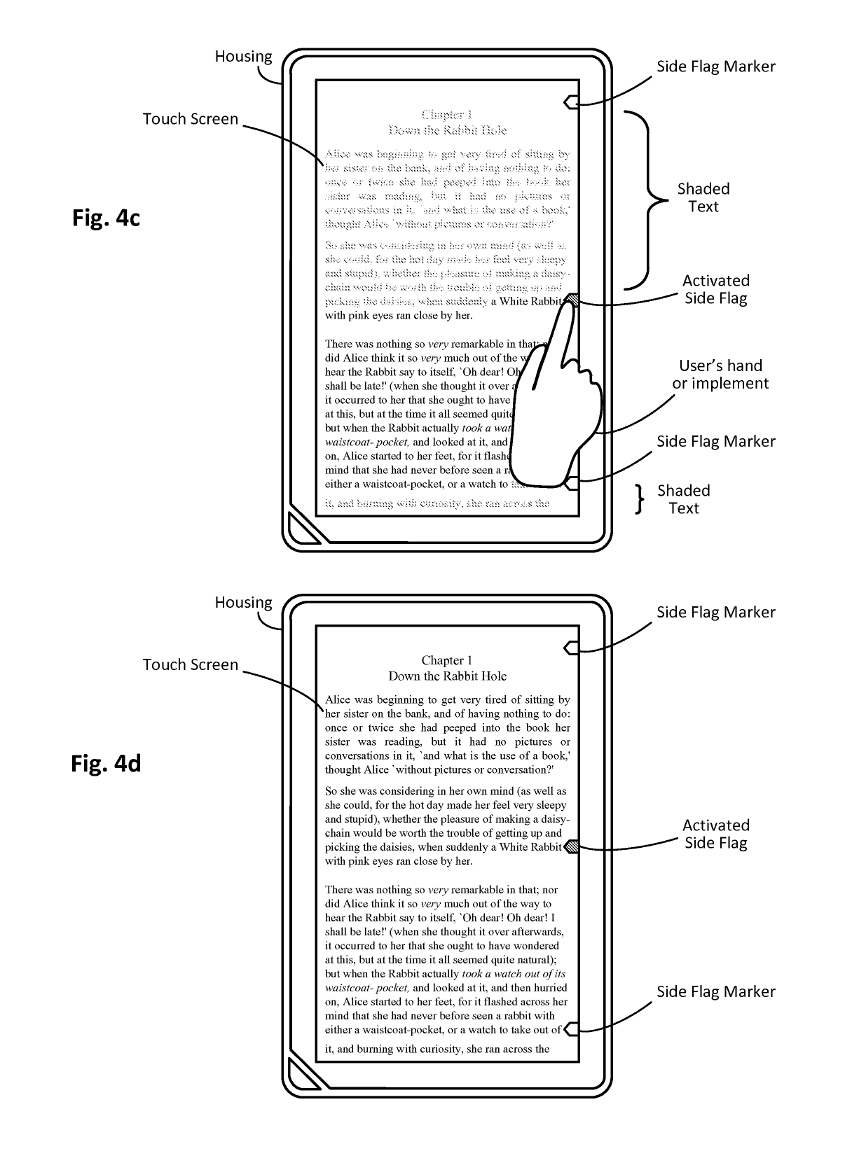

FIGS. 4a-d collectively illustrate an example electronic touch screen device having multiple side flags in one viewport, in accordance with another embodiment of the present invention. As can be seen in FIG. 4a, the device housing surrounds the touch screen of the device, and the device is displaying the first page of an eBook to the user. In this example embodiment, the user can interact with the touch screen with fingers or any other suitable implement, and in the upper right corner of the screen a side flag marker or place holder is displayed. In this particular embodiment, a single side flag place holder is associated with a single page of text set at a certain font size and margin format and currently the device viewport is displaying only a single page of text. In such an example, the side flags track the original page numbering of a piece of physical content, in this case a book. In some embodiments, where no physical page numbering exists (e.g., a digital-only publication, or where the publisher has not specified a page numbering), a virtual page number may be displayed based on what is defined as the start and end page range for any given “page” of content. As can be seen in FIG. 4b, when the user decreases the font size of the digital content, the text reflows within the viewport. In this example, the viewport is now displaying more than two pages worth of text, and therefore three side flags are shown in a single viewport.

As can be seen in FIG. 4c, the user may wish to activate a side flag associated with the content in the third paragraph of the book, which in this example is the second side flag. As can be seen in this example, the user performs a simple tap gesture over the second side flag marker in order to activate the side flag in the default color, which is blue in this example. As discussed above, when a multiple side flags are displayed on a single viewport and one flag is activated, the shading of all text not associated with the newly activated side flag may decrease temporarily, in some embodiments. Such an animation may help the user view what content is being flagged, and in some embodiments a sound effect may accompany the shading animation. In one such example, the content not associated with the newly activated side flag is shaded for a short interval (e.g., two seconds), and then slowly regains full opacity, as seen in FIG. 4d.

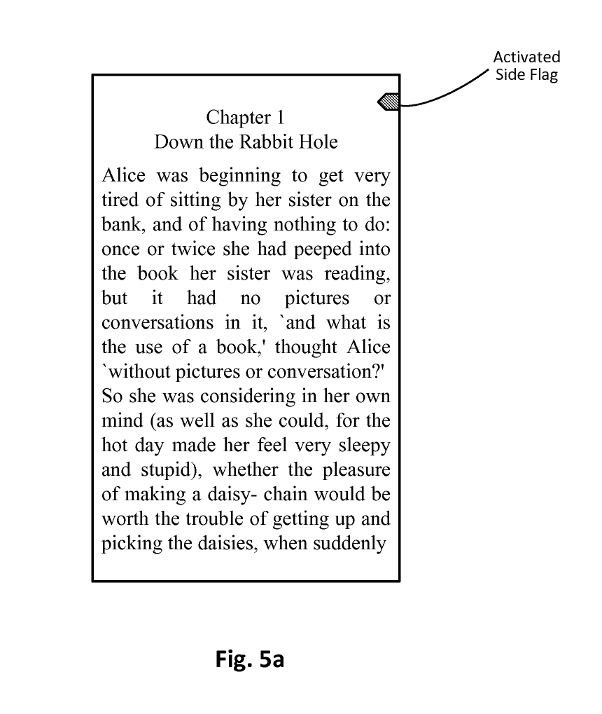

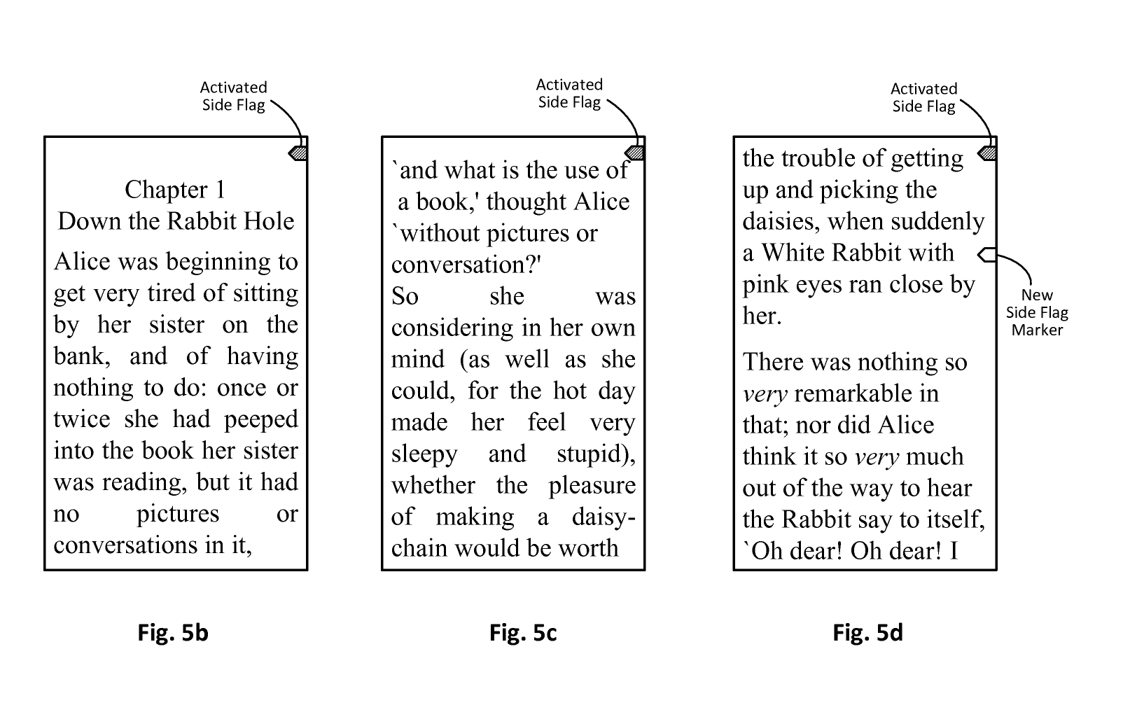

FIGS. 5a-d illustrate example screen shots showing a single side flag spanning multiple viewports, in accordance with an embodiment of the present invention. As can be seen in FIG. 5a, the screen is showing the first chapter of an eBook and in the upper right corner of the screen an activated side flag is displayed. In this particular embodiment, a single side flag is associated with a single page of text set at a certain font size and margin format, and currently a single screen is displaying a single page of text. In such an example, the side flag tracks the original page numbering of a piece of physical content, in this case a book. As can be seen in FIGS. 5b-d, when the user increases the font size of the digital content, the text reflows within the screen such that the content displayed in FIG. 5a must be spread over three screen shots in FIGS. 5b-d.

In this example, the screen shot in FIG. 5a continues to display the activated side flag in the upper right corner, while the screen shot in FIG. 5b also displays an activated side flag because the content displayed on that screen is associated with the original side flag from FIG. 5a before the text was reflowed from its original page numbering. Furthermore, in this example, the screen shot in FIG. 5d also includes an activated side flag in the upper right corner because the initial content on that screen is associated with the original side flag from FIG. 5a, while a new side flag marker is displayed partially down the screen to mark the original page break of FIG. 5a. In this specific example, the activated side flags displayed in FIGS. 5c-d are merely extensions of the first side flag from FIG. 5a. More generally, any time text is reflowed to cover more viewports or screen shots, the side flag is repeated in as many screen shots as needed. As discussed above, if the user were to turn off the flag of change its color in one screen (e.g., in FIG. 5c), that change would be reflected across all the viewports encompassed by that side flag, in some embodiments.

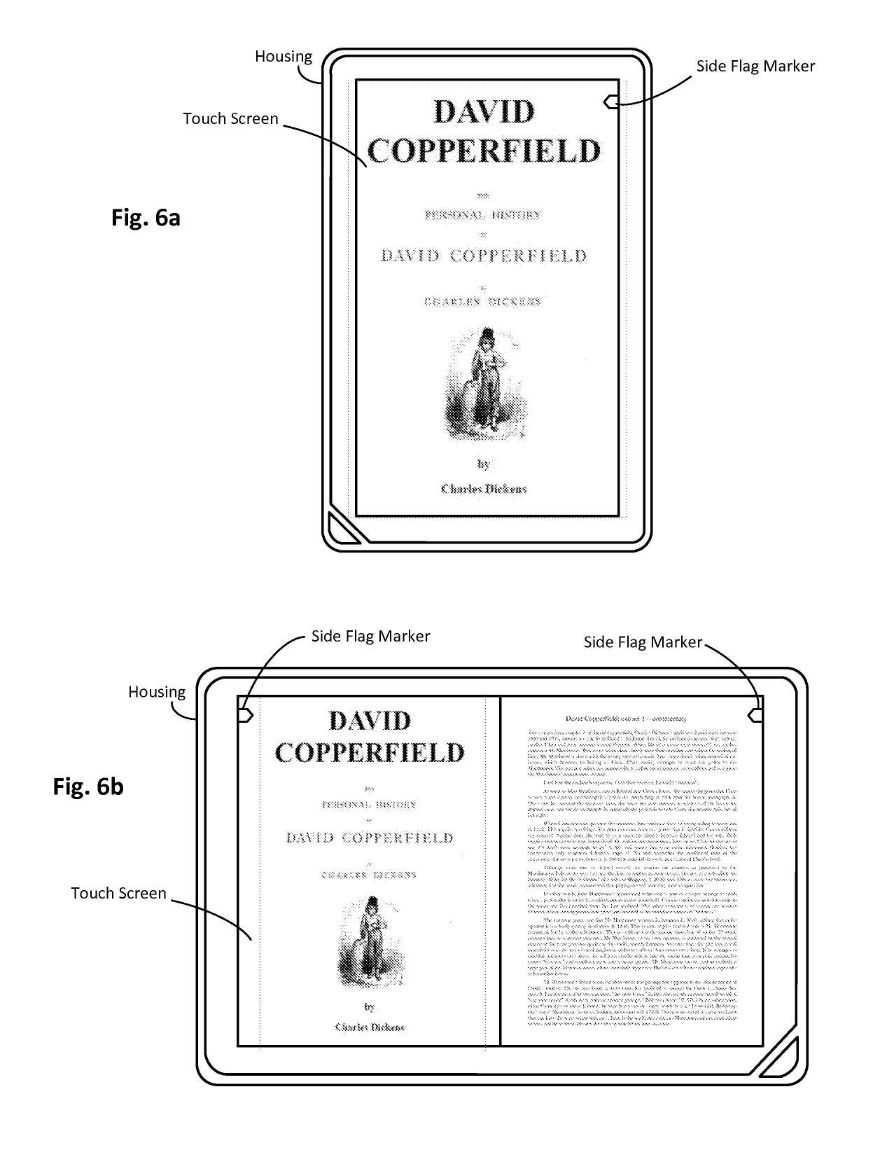

FIGS. 6a-b collectively illustrate different side flag positions bases on the orientation of an electronic touch screen device, in accordance with an embodiment of the present invention. As can be seen in FIG. 6a, the device housing surrounds the touch screen of the device, and the device is displaying the first page of a digital content item. In some embodiments, the digital content may be a fixed format PDF or ePub file (or any other suitable fixed format file), or may be reflowable content. In this specific example, the digital content is a fixed format PDF file without reflowable text. In this embodiment, the user is holding the device in the portrait orientation and a side flag marker or place holder is displayed in the upper right hand corner of the screen, and this portion of the screen may be exclusively reserved for flagging gestures. As can be seen in FIG. 6b, when the user rotates the device to display content in the landscape mode, a two-page spread may be displayed to the user. In some embodiments, when the pages are readjusted into landscape orientation, the flag for the page on the right is located in the upper right corner of the device screen, while the flag for the page on the left appears in the upper left corner of the device screen. In this embodiment, both the areas in the upper left and upper right corners of the screen may be exclusively reserved for flagging gestures.

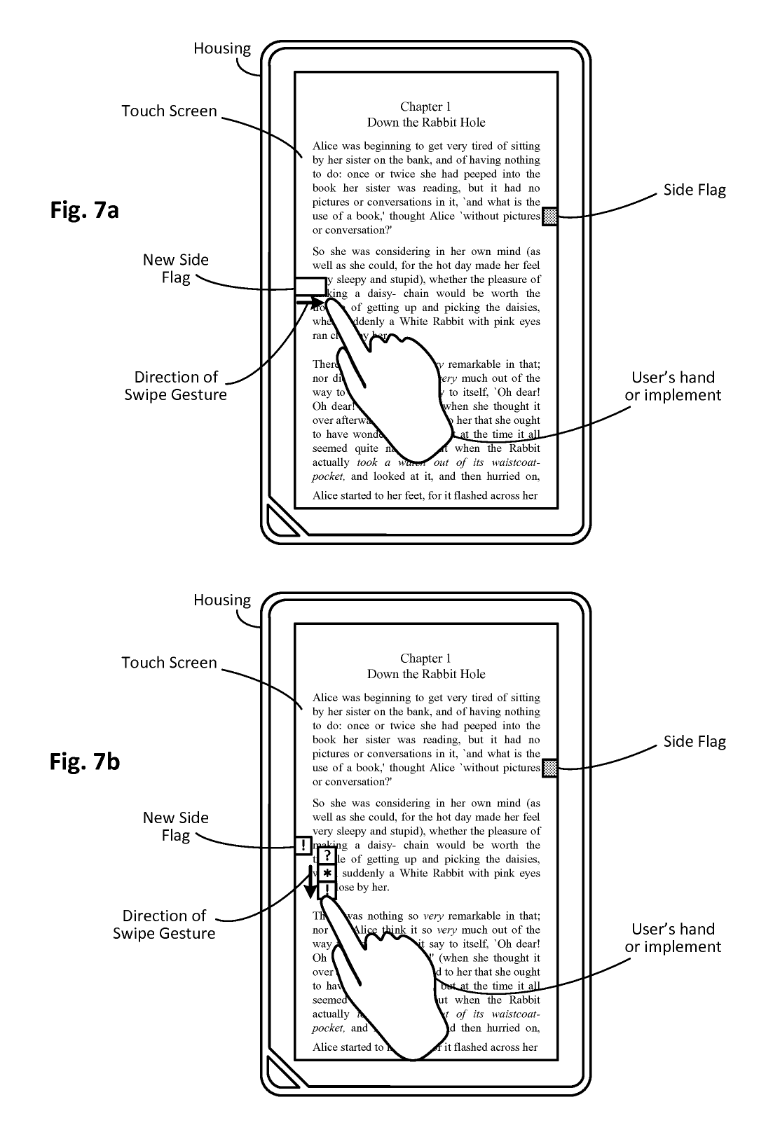

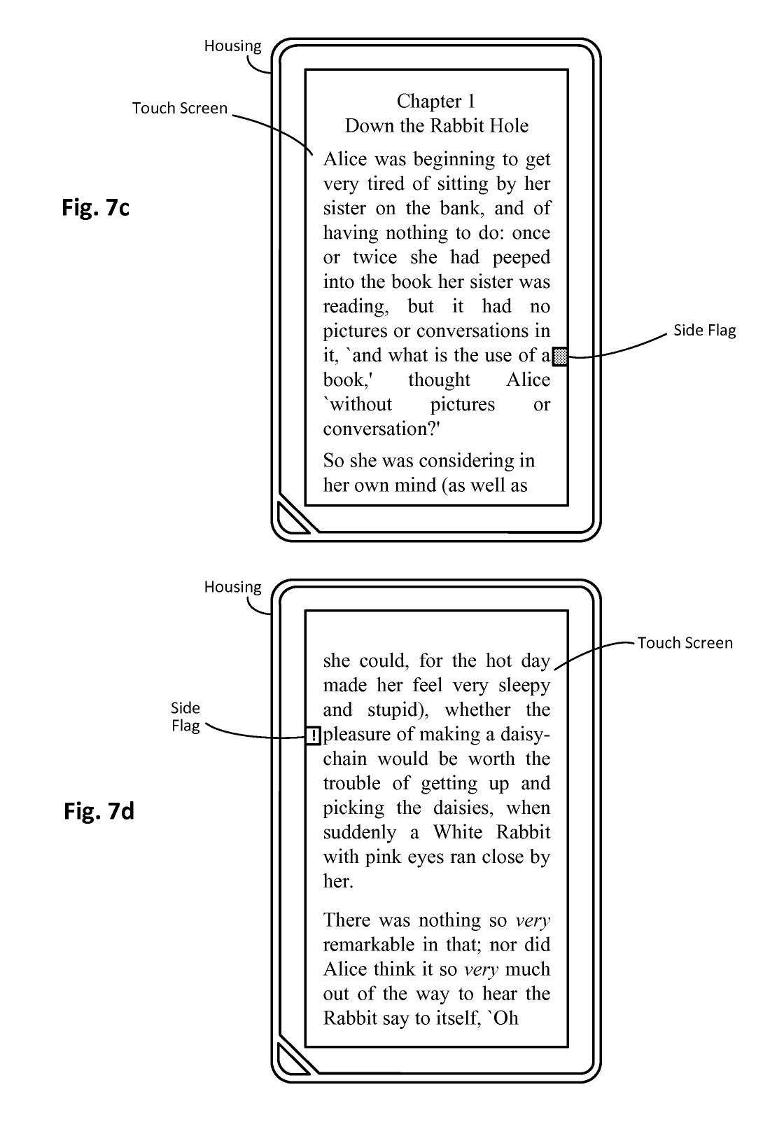

FIGS. 7a-d collectively illustrate examples of side flags linked to reflowable digital content, in accordance with an embodiment of the present invention. As can be seen in FIG. 7a, the device housing surrounds the touch screen of the device, and the device is displaying the first page of an eBook to the user. In this example embodiment, the user can interact with the touch screen with fingers or any other suitable implement, and on the right side about a third of the way down the page, a first shaded side flag is displayed. As discussed above, in some embodiments the user may create side flags at various sections of a page in order to bookmark distinct lines of text. This may be done, for example, by performing a swipe gesture away from the edge of the device screen, such that a side flag appears to be pulled out of the edge of the screen. In other embodiments, a side flag place holder may be located in a corner of the screen and the user may drag it to a specific line of text to activate the side flag and link it to that specific section of flowable text. In one such embodiment, the side flag is linked to the first word of a line such that it will follow that word when the text is reflowed. As can be further seen, the user is pulling a side flag from the left edge of the screen in order to bookmark the line beginning with the word “making” Similarly, the shaded side flag is linked to the line beginning with the word “use.”

As can be seen in FIG. 7b, in addition to color coding the side flags, in some embodiments the user may apply a label or icon to a side flag. In this specific example, the user may select a question mark, asterisk, or exclamation point, for a the newly created side flag to denote that the user has a question about the flagged material, that the flagged material may be on a test, or that the flagged material is important. In this embodiment, the user selects the exclamation point for this particular side flag. In this particular embodiment, the side flags are linked to the flowable content rather than a page number, such that when formatting changes are applied to the text the flags follow the content they are assigned to. As can be seen in FIGS. 7c-d, when the user increases the font size of the digital content, the text reflows within the viewport such that the content displayed in FIG. 7a must be spread over multiple viewports. As can be seen in FIG. 7c, the shaded side flag follows the first word of the line of text it was originally assigned to, which in this case is the word “use.” Similarly, as can be seen in FIG. 7d, the newly created side flag with an exclamation mark follows the first word of the line it was originally assigned to, which in this case is the word “making.”

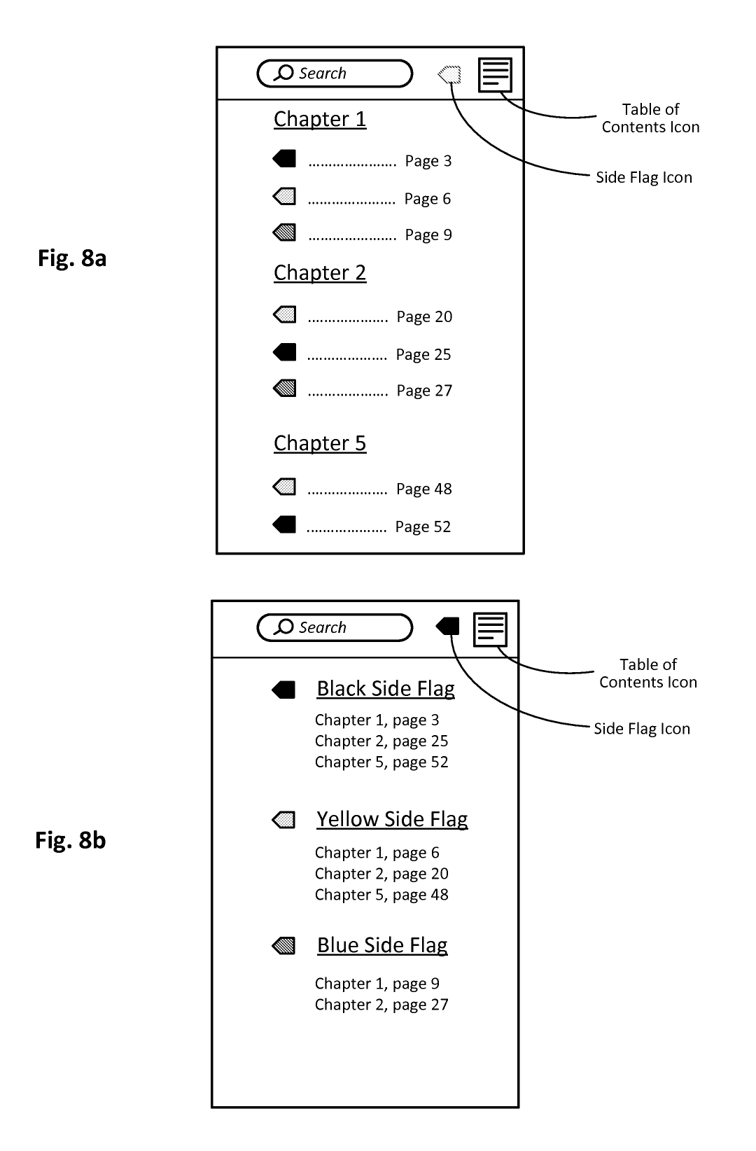

FIGS. 8a-b illustrate screen shots of a side flag table of contents, in accordance with two embodiments of the present invention. As discussed above, in some embodiments the side flag mode allows the user to view a table of contents that shows only the pages of digital content having activated side flags. In one such example, certain pages of a digital textbook may be marked for further study, and such a table of contents can allow the user to create an outline or quickly review important sections of the textbook. As can be seen in FIG. 8a, the table of contents screen includes a search bar, a side flag icon, and a table of contents icon in the upper portion of the screen. In this example, the side flag icon is slightly shaded, indicating that the table of contents is organized by the content headings rather than by the side flags. The screen also displays the names of chapters including pages with activated side flags. In this particular example, chapters 1, 2, and 5 have flagged pages. As can be further seen, within chapter 1 a black side flag is located at page 3, a yellow flag at page 6, and a blue flag at page 9; within chapter 2 a yellow flag is located at page 20, a black flag at page 25, and a blue flag at page 27; and within chapter 5 a yellow flag is located at page 48 and a black flag at page 52. In some embodiments, the chapter titles and page numbers may include links to the relevant chapters and/or pages such that the user may easily navigate to a desired location within the digital content.

An alternative side flag table of contents layout is illustrated in the example of FIG. 8b. In this particular example, a search bar, side flag icon, and table of contents icon are also included in the upper portion of the screen, however side flag icon is fully darkened, indicating that the table of contents is organized by side flags rather than by a chapter and page structure. In some embodiments, the screen shots shown in FIGS. 8a-b are of a touch screen display and the user may toggle between the different views shown in FIGS. 8a-b by tapping the side flag icon. In this particular example, the table of contents shows that black side flags are located at chapter 1 page 3, chapter 2 page 25, and chapter 5 page 52; yellow side flags are located at chapter 1 page 6, chapter 2 page 20, and chapter 5 page 48; and blue side flags are located at chapter 1 page 9, and chapter 2 page 27. As mentioned above, the chapter titles and page numbers may include links to the relevant chapters and/or pages such that the user may easily navigate to a desired location within the digital content, in some embodiments. As will be appreciated, the two organizational schemes in FIGS. 8a-b are shown for illustrative purposes only, and the table of contents may be organized in any number additional ways, and the disclosure is not intended to be limited to any particular table of contents organizational structure.

Methodology

FIG. 9 illustrates a method for providing a side flag mode in an electronic touch screen device, in accordance with an embodiment of the present invention. This example methodology may be implemented, for instance, by the UI module of the example touch screen device shown in FIG. 2a, or the example touch screen device shown in FIG. 2b (e.g., with the UI provisioned to the client by the server). To this end, the side flag mode can be implemented in software, hardware, firmware, or any combination thereof, as will be appreciated in light of this disclosure.

As can be seen, the method generally includes sensing a user's input by a touch screen display. As soon as the user begins to swipe, drag or otherwise move a contact point, the UI code (and/or hardware) can assume a swipe gesture has been engaged and track the path of the contact point with respect to any fixed point within the touch screen until the user stops engaging the touch screen surface. The release point can also be captured by the UI as it may be used to commit the action started when the user pressed on the touch sensitive screen. In a similar fashion, if the user releases hold without moving the contact point, a tap or press or press-and-hold command may be assumed depending on the amount of time the user was continually pressing on the touch sensitive screen. These main detections can be used in various ways to implement UI functionality, including a side flag mode as variously described herein, as will be appreciated in light of this disclosure.

In this example case, the method includes detecting 901 a user contact on the touch sensitive interface. As described above, the contact may be performed in any suitable manner using a stylus, the user's finger, or any other suitable implement, and it may be performed on a touch screen surface, a track pad, acoustic sensor, or other touch sensitive surface. The user contact monitoring is essentially continuous. In other embodiments, the user input may be, for example, a mouse-based signal, or any other user interface input. Once a user contact or other input has been detected, the method may continue with determining 902 whether a simple side flag activation gesture has been detected. In some cases, performing a single tap gesture, or other distinguishable touch screen gesture, over a side flag place holder may enable that side flag. If a simple activation gesture has been detected, the method may continue with creating 903 a side flag at the default color. In some embodiments, the default color may be user configured or hard-coded, while in other cases the default color is the color last used to activate a side flag. If no simple activation gesture is detected at 902, the method may continue with determining 904 whether a color viewing gesture is detected. As described above, in some cases the color viewing gesture may be user configured or hard-coded, and may be a swipe gesture performed over a side flag place holder away from the edge of the device screen. If the color viewing gesture is detected, the method may continue with displaying 905 the available color options. The method may continue with determining 906 whether a color selection is detected. If a color selection is detected, the method may continue with creating 907 a side flag having the selected color. If no color selection is detected, the method may continue with exiting 908 the side flag mode. In some embodiments, if the user does not select a color option within a certain time interval (e.g., four seconds after the color options are displayed), the side flag mode may be exited. Likewise, a tap or other touch screen gesture performed away from the color options being displayed may cause the side flag mode to be exited.

If no color viewing gesture is detected at 904, however, the method may continue with determining 909 whether an icon viewing gesture is detected. As discussed above, the various side flags may be assigned an icon which may include an exclamation mark, question mark, asterisk, or other similar identifier, and in some embodiments the icon viewing gesture may be hard-coded or configured by the user. In one example, the icon viewing gesture may be a vertical swipe gesture, or other distinguishable touch screen gesture, performed over a side flag indicating that the user wishes to view the available side flag icons. If no icon viewing gesture is detected, the contact may be reviewed 910 for some other UI request. If an icon viewing gesture is detected, the method may continue with displaying 911 the icon options. The method may continue with determining 912 whether an icon selection is detected. If an icon selection is detected, the method may continue with creating 913 a side flag having the selected icon. If no icon selection is detected, the method may continue with exiting 908 the side flag mode. In some embodiments, if the user does not select an icon within a certain time interval (e.g., four seconds after the icon options are displayed), the side flag mode may be exited. Likewise, a tap or other touch screen gesture performed away from the icon options being displayed may cause the side flag mode to be exited.

Numerous variations and embodiments will be apparent in light of this disclosure. One example embodiment of the present invention provides a device including a touch screen display for displaying reflowable digital content to a user and allowing user input. The device also includes a user interface including a side flag mode configured to activate a side flag in response to a side flag activation gesture, wherein the side flag is linkable to a section of the reflowable digital content and is configured to follow that section of content in response to the digital content reflowing on the display. In some cases, the side flag mode is further configured to assign a color to the side flag in response to a color selection gesture. In some cases, the side flag activation gesture is a tap gesture performed over a side flag marker. In some cases, the side flag mode is further configured to deactivate the side flag in response to a tap gesture being performed over an activated side flag. In some cases, the side flag mode is further configured to: display a plurality of color options in response to a color viewing gesture; assign the side flag a color in response to a color selection gesture; and deactivate an activated side flag in response to a color selection gesture selecting a current side flag color. In some cases, activating a side flag includes assigning an icon to the side flag in response to an icon selection gesture. In some cases, the side flags are linked to the first word of each page of an original page numbering of the reflowable digital content. In some cases, in response to the device being held in a landscape orientation, the side flag mode is further configured to display a two-page spread with one or more side flags for the right page on the right margin and one or more side flags for the left page on the left margin. In some cases, a single side flag can be associated with multiple viewports of digital content, each viewport displaying the side flag, and wherein the side flags on each of the multiple viewports are configured to activate in response to the side flag being activated on any of the multiple viewports. In some cases, multiple side flags are displayed in one viewport, and the side flag mode is configured to allow independent activation and deactivation of each side flag. In some such cases, multiple side flags are displayed in one viewport, and wherein the side flag mode is further configured to, in response to a user activating only one of the side flags, display an animation partially obscuring any text not related to the newly activated side flag. In some cases, the side flag mode is further configured to create a table of contents organized based on activated side flags.

Another example embodiment of the present invention provides a mobile computing system including a processor and a touch screen display for displaying reflowable digital content to a user and allowing user input. The system also includes a user interface executable on the processor and including a side flag mode configured to activate a side flag in response to a side flag activation gesture, wherein the side flag is linkable to a section of the reflowable digital content so that it follows that section of content in response to the digital content reflowing on the display. In some cases, the side flag mode is further configured to deactivate an activated side flag in response to a deactivation gesture. In some cases, the side flag mode is further configured to display a plurality of color options in response to a color viewing gesture, assign the side flag a color in response to a color selection gesture, and deactivate an activated side flag in response to a color selection gesture selecting a current side flag color. In some cases, the side flag activation gesture includes at least one of a tap gesture and/or mouse click performed over a side flag marker.

Another example embodiment of the present invention provides a computer program product including a plurality of instructions non-transiently encoded thereon and executable by one or more processors to carry out a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to receive at an electronic device a side flag activation gesture; display via the electronic device an activated side flag, wherein an activated side flag includes a colored side flag that is linkable to a section of reflowable digital content; and display via the electronic device the side flag proximal to the section of reflowable digital content to which it is linked after a reflow event. In some cases, the process further includes receive at the electronic device a side flag color selection; and assign a selected color to the side flag. In some cases, the side flag activation gesture includes at least one of a single-contact tap gesture performed on a touch screen surface of the electronic device over a side flag marker, and/or a mouse click performed over a side flag marker. In some cases, the process further includes display on the electronic device a table of contents organized based on the side flags.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a touch screen display for displaying reflowable digital content to a user and allowing user input; and
a user interface including a side flag mode configured to activate a side flag in response to a side flag activation gesture, wherein the side flag is linkable to a section of the reflowable digital content and is configured to follow that section of content in response to the digital content reflowing on the display.

2. The device of claim 1 wherein the side flag mode is further configured to assign a color to the side flag in response to a color selection gesture.

3. The device of claim 1 wherein the side flag activation gesture is a tap gesture performed over a side flag marker.

4. The device of claim 1 wherein the side flag mode is further configured to deactivate the side flag in response to a tap gesture being performed over an activated side flag.

5. The device of claim 1 wherein the side flag mode is further configured to: display a plurality of color options in response to a color viewing gesture; assign the side flag a color in response to a color selection gesture; and deactivate an activated side flag in response to a color selection gesture selecting a current side flag color.

6. The device of claim 1 wherein activating a side flag comprises assigning an icon to the side flag in response to an icon selection gesture.

7. The device of claim 1 wherein the side flags are linked to the first word of each page of an original page numbering of the reflowable digital content.

8. The device of claim 1 wherein in response to the device being held in a landscape orientation, the side flag mode is further configured to display a two-page spread with one or more side flags for the right page on the right margin and one or more side flags for the left page on the left margin.

9. The device of claim 1 wherein a single side flag can be associated with multiple viewports of digital content, each viewport displaying the side flag, and wherein the side flags on each of the multiple viewports are configured to activate in response to the side flag being activated on any of the multiple viewports.

10. The device of claim 1 wherein multiple side flags are displayed in one viewport, and wherein the side flag mode is configured to allow independent activation and deactivation of each side flag.

11. The device of claim 10 wherein multiple side flags are displayed in one viewport, and wherein the side flag mode is further configured to, in response to a user activating only one of the side flags, display an animation partially obscuring any text not related to the newly activated side flag.

12. The device of claim 1 wherein the side flag mode is further configured to create a table of contents organized based on activated side flags.

13. A mobile computing system, comprising:
a processor and a touch screen display for displaying reflowable digital content to a user and allowing user input; and
a user interface executable on the processor and including a side flag mode configured to activate a side flag in response to a side flag activation gesture, wherein the side flag is linkable to a section of the reflowable digital content so that it follows that section of content in response to the digital content reflowing on the display.

14. The system of claim 13 wherein the side flag mode is further configured to deactivate an activated side flag in response to a deactivation gesture.

15. The system of claim 13 wherein the side flag mode is further configured to: display a plurality of color options in response to a color viewing gesture; assign the side flag a color in response to a color selection gesture; and deactivate an activated side flag in response to a color selection gesture selecting a current side flag color.

16. The system of claim 13 wherein the side flag activation gesture comprises at least one of a tap gesture and/or mouse click performed over a side flag marker.

17. A computer program product comprising a plurality of instructions non-transiently encoded thereon and executable by one or more processors to carry out the following process, the process comprising:
receive at an electronic device a side flag activation gesture;
display via the electronic device an activated side flag, wherein an activated side flag comprises a colored side flag that is linkable to a section of reflowable digital content; and
display via the electronic device the side flag proximal to the section of reflowable digital content to which it is linked after a reflow event.

18. The computer program product of claim 17, the process further comprising: receive at the electronic device a side flag color selection; and assign a selected color to the side flag.

19. The computer program product of claim 17 wherein the side flag activation gesture comprises at least one of a single-contact tap gesture performed on a touch screen surface of the electronic device over a side flag marker, and/or a mouse click performed over a side flag marker.

20. The computer program product of claim 17, the process further comprising: display on the electronic device a table of contents organized based on the side flags.
